(19) United States
(12) Patent Application Publication
(10) Pub. No.: US 2012/0055808 A1
(43) Pub. Date: Mar. 8, 2012

(54) PROCESS FOR THE ELECTROLYTIC DISSOCIATION OF HYDROGEN SULFIDE

(75) Inventors: Marc Claude Martin, Lemforde (DE); Günther Huber, Ludwigshafen (DE); Rüdiger Schmidt, Ludwigshafen (DE); Martin Scholtissek, Wachenheim (DE); Heinrich Driever, Habichtswald (DE)

(73) Assignee: BASF SE, Ludwigshafen (DE)

(21) Appl. No.: 13/320,153

(22) PCT Filed: May 12, 2010
(86) PCT No.: PCT/EP2010/056565

§ 371 Date: Nov. 11, 2011

(30) Foreign Application Priority Data
May 14, 2009 (EP) 09160208.6

(51) Int. Cl. B01D 53/32; C25B 1/00

(52) U.S. Cl. 205/763

(57) ABSTRACT

The invention relates to a process for the electrolytic dissociation of hydrogen sulfide dissolved in an amine scrubber solution in an electrolysis cell (11) which has an anode space (9) and a cathode space (15), with the anode space (9) and the cathode space (15) being separated by a membrane (13), in which at least one supporting electrolyte is added to the amine scrubber solution, an anion-conducting membrane is used for separating anode space (9) and cathode space (15) and/or the amine scrubber solution in which the hydrogen sulfide is dissolved comprises at least 10% by volume of potassium N,N-dimethylaminoacetate. The invention further relates to a use of the process.

The invention relates to a process for the electrolytic dissociation of hydrogen sulfide dissolved in a liquid in an electrolysis cell which has an anode space and a cathode space, with the anode space and the cathode space being separated by a membrane.

Petroleum, natural gas, coal and biomass are frequently used as raw materials for energy generation and for producing chemical products. These raw materials generally comprise a proportion of organosulfur compounds. On combustion or work-up, the sulfur remains in the offgases in the form of sulfur oxides which are harmful to the climate and the environment. For these reasons, great efforts have been made to remove sulfur from the raw materials mentioned before they are burnt or processed further. The most widely used method of removing sulfur is hydrogenation. In this case, sulfur-comprising compounds are eliminated as hydrogen sulfide gas. A further great challenge at present is to separate off the hydrogen sulfide obtained from the product of value and to convert the toxic hydrogen sulfide gas into nontoxic sulfur which can be disposed of in a landfill.

Gas scrubbers have been found to be useful for separating off the hydrogen sulfide from hydrocarbon-comprising gas mixtures. Gas scrubber solutions comprise, as active constituent, relatively nonvolatile amines, for example methyldiethanolamine (MDEA), diethanolamine (DEA), etc., which dissolve acidic hydrogen sulfide from the hydrocarbon-comprising gas mixture by physisorption and chemisorption and at the same time do not adversely affect the hydrocarbon. Industrial-scale gas scrubbers generally simultaneously dissolve other acidic gases such as CO₂ from the gas mixture. The gas scrubber solutions are usually heated in a second step so as to desorb the dissolved gases again. The hydrocarbon-free waste gas mixture is then, in a third step, reacted with air or oxygen according to the Claus process at temperatures of about 300° C. to form elemental sulfur and water vapor. The Claus process has been continuously improved in recent decades but still suffers from a high energy consumption, poor controlability and high emissions associated therewith and also costly safety measures due to the handling of toxic gases at high temperature and pressure. A further disadvantage is that the hydrogen required for hydrogenating the organosulfur compounds is lost as raw material due to the reaction in the Claus process. Since hydrogen is generally produced from hydrocarbons by reforming, a not insignificant proportion of product of value is lost in the removal of sulfur.

As an alternative, the electrolytic dissociation of absorbed hydrogen sulfide into sulfur and hydrogen is also known. In general, polysulfides are formed from the sulfide of the hydrogen sulfide at the anode of an electrolysis cell. These decompose, for example, on acidification to form sulfur, sulfide and hydrogen sulfide. The sulfur obtained can then be taken from the electrolysis cell. At the cathode of the electrolysis cell, water is reduced to hydrogen and hydroxide ions. The hydroxide ions replace the alkali which has been consumed by the reaction with hydrogen sulfide so that the alkali circuit is closed and no alkali is consumed. To balance the charge, cations of the alkali migrate through the membrane of the electrolysis cell from the anode space into the cathode space. In this way, hydrogen and sulfur are formed as end products.

U.S. Pat. No. 3,409,520 discloses, for example, passing a gas mixture of hydrogen sulfide and hydrocarbon into an electrolysis cell and bringing it into contact with the electrolyte and the anode. As electrolyte, use is made here of an aqueous solution of a sodium salt or a compound comprising ammonium ions or potassium. The hydrogen sulfide is introduced directly into the electrolysis cell here. This process is not suitable for industrial use.

The documents U.S. Pat. No. 3,249,522 and U.S. Pat. No. 5,019,227, too, disclose the decomposition of hydrogen sulfide into sulfur and hydrogen by electrolysis, with polysulfides and hydrogen initially being formed and the polysulfides subsequently decomposing into sulfide and elemental sulfur. The electrolysis is carried out in an aqueous electrolyte which generally comprises an alkali metal salt. Ammonium hydroxide is also mentioned as an alternative electrolyte in U.S. Pat. No. 3,249,522. The ammonium hydroxide is in this case used as anolyte.

The use of ammonium hydroxide as electrolyte for the electrolysis of hydrogen sulfide is also known from U.S. Pat. No. 4,765,873. Organic amine compounds which form ammonium ions in aqueous solution have been described as electrolyte for the electrolysis of hydrogen sulfide in U.S. Pat. No. 5,908,545.

A disadvantage of the use of ammonium hydroxide as electrolyte is that NH₃ can escape as pollutant into the environment and the carbon dioxide which is likewise dissolved in the scrubbing solution of industrial amine scrubbers combines with the cations of the alkali used as electrolyte to form carbonates which precipitate and can thus block the membrane. In addition, alkali is consumed by carbonate formation and then has to be replaced for the further electrolysis. At the same time, large amounts of water have to be discharged. This is firstly associated with a high energy consumption and, secondly, a thermal removal of water cannot be carried out without desorption of the gases dissolved therein. In addition, none of the processes disclosed is suitable for removing hydrogen sulfide from an industrial amine scrubber solution. This can be attributed, in particular, to the fact that the ions of the amines used which are formed in industrial amine scrubber solutions are too large to migrate through the membrane.

It is an object of the present invention to provide a process which makes electrolytic dissociation of hydrogen sulfide dissolved in an amine scrubber solution in an electrolysis cell possible.

The object is achieved by a process for the electrolytic dissociation of hydrogen sulfide dissolved in an amine scrubber solution in an electrolysis cell which has an anode space and a cathode space, with the anode space and the cathode space being separated by a membrane. In the process, at least one of the following features is realized:
(a) addition of at least one supporting electrolyte to the amine scrubber solution,
(b) use of an anion-conducting membrane for separating anode space and cathode space or
(c) the amine scrubber solution in which the hydrogen sulfide is dissolved comprises at least 10% by volume of potassium N,N-dimethylaminoacetate.

An advantage of the process of the invention is that the electrolysis for dissociation of the hydrogen sulfide can also be carried out using industrial amine scrubber solutions.

When at least one supporting electrolyte is added to the amine scrubber solution and/or the amine scrubber solution comprises at least 10% by volume of potassium N,N-dimethylaminoacetate, a cation-conducting membrane is used as membrane separating the anode space and cathode space.

Amine scrubbers are used to remove hydrogen sulfide from offgases which arise, for example, in the refining of hydrocarbons, in coal gasification, in the refining and desulfurization of renewable raw materials and also in biogas production. Amine scrubbers are likewise used to remove hydrogen sulfide from natural gas. Apart from hydrogen sulfide, the gas streams generally further comprise carbon dioxide, carbon monoxide, carbon oxide sulfide, carbon sulfide, mercaptans, thiols and ammonia. The carbon dioxide can be comprised in large amounts in the gas stream. In known processes based on alkali or NH₄ solutions, the carbon dioxide causes difficulties since it reacts in aqueous hydroxide solution to form carbonates. Here, alkali equivalents are consumed by the carbon dioxide and these are then no longer available for the chemical dissolution of hydrogen sulfide and are also not regenerated in the electrolysis. In the electrolysis of aqueous alkaline solutions, it is therefore necessary in the case of a mixture of carbon dioxide and hydrogen sulfide to introduce alkali in proportion to the amount of carbon dioxide, which can incur high costs. For this reason, high-boiling amine solutions are at present used for the scrubbing of gas streams. These solutions have a low vapor pressure. A gas stream contaminated with hydrogen sulfide, carbon dioxide and possibly other components is scrubbed by the amine solution, with the gas stream being freed of all soluble components. The purified gas leaves the amine solution in unchanged form. Gases used are, for example, hydrocarbons. The impurities such as hydrogen sulfide and carbon dioxide are dissolved in the amine solutions. These amine solutions loaded with impurities are at present heated in a second reactor and hydrogen sulfide, carbon dioxide and the other impurities are desorbed again.

The amine scrubber solutions used generally have only a very low specific conductivity and are therefore unsuitable for electrochemical processes. However, when hydrogen sulfide from the gas stream is absorbed in the amine scrubber solution, a hydrogen ion of the hydrogen sulfide is bound to the nitrogen of the amine, resulting in formation of an amine cation. In this way, the corresponding salts of the amine with hydrogensulfide as counterion are formed. This increases the conductivity of the solution, so that the conductivity would be sufficient to carry out an electrolysis. However, this electrolysis does not work in the case of the known processes since the cations are too large to pass through the cation-conducting membranes used. The cell resistance of the membrane is too great and only low currents can be achieved. An industrial electrolysis is therefore not possible. At a relatively high loading of the cell, the membrane ruptures because of the size of the ions.

It has been found that addition of the at least one supporting electrolyte to the liquid results in a conductivity which is sufficiently high to be able to carry out an electrolysis; in addition, the supporting electrolyte also makes it possible to carry out an electrolysis because the cations of the added supporting electrolyte can pass through the membrane. Furthermore, it has been found that the addition of the supporting electrolyte to the liquid does not adversely affect the absorption capability of the amine scrubber solution for hydrogen sulfide. Surprisingly, the selectivity between supporting electrolyte cation and amine cation is so high that the membrane is not damaged even at high current densities. Furthermore, it has been found that the absorption of carbon dioxide, which is bound weakly by physisorption in the amine scrubber solution, does not interfere in the electrolysis. The addition of the supporting electrolyte also does not liberate any free alkali, so that carbonate formation is suppressed. This leads to carbon dioxide being absorbed to saturation in the amine scrubber solution and, when saturation is reached, no further carbon dioxide can be absorbed from the scrubber.

A further industrially important problem associated with the processes known from the prior art is passivation of the anode of the electrolysis cell by sulfur. However, in the process of the invention, sulfur only precipitates when the pH drops below a value which is dependent on the amine of the amine scrubber solution. However, the pH can be monitored in a simple manner and makes targeted adjustment of the electrolysis possible. It is possible to keep the pH of the amine scrubber solution at a value at which the sulfur remains dissolved in the amine scrubber solution by, for example, targeted addition of acid or alkali. Suitable acids or alkalis for setting the pH are, for example, mineral acids, for example sulfuric acid, nitric acid, hydrochloric acid or phosphoric acid, and/or hydroxides of the alkali metals, in particular sodium hydroxide, potassium hydroxide or lithium hydroxide.

Suitable supporting electrolytes which can be added to the amine scrubber solution are, in particular, salts of an alkali metal. Suitable alkali metals are, in particular lithium, sodium and potassium.

The anion of the supporting electrolyte is preferably selected from the group consisting of sulfate, sulfide, phosphate, hydroxide, halide, carbonate and hydrogensulfide. When the anion is a halide, a chloride is particularly preferred.

Very particularly preferred supporting electrolytes are alkali metal chlorides and among these more particularly sodium chloride.

Apart from the inorganic salts mentioned, the supporting electrolyte can alternatively also be an organic salt of an alkali metal or alkaline earth metal. Suitable organic salts of the alkali or alkaline earth metals are, for example, typical organic supporting electrolytes, for example relatively small water-soluble carboxylates, in particular formates, acetates and oxalates, and also all types of deprotonated amino acids.

The proportion of supporting electrolyte in the amine scrubber solution comprising the hydrogen sulfide is preferably in the range from 1 to 13.8% by weight. The proportion of supporting electrolyte is preferably close to the saturation limit. The molar ratio of supporting electrolyte to dissolved hydrogen sulfide is preferably in the range from 1 to 2.

The solution formed in the electrolysis is preferably removed from the anode space before formation of trisulfides. The solution removed from the anode space is acidified outside the electrolysis cell. This results in decomposition of the disulfides into sulfur and sulfides, with the sulfur precipitating. The sulfur formed can be filtered readily and is separated off from the remaining solution. After the sulfur has been separated off, the solution is introduced into the cathode space. The salt formed from the amine cation and the anion of the supporting electrolyte is deprotonated in the cathode space by the hydroxide ions formed there, so that the electrolyte salt and free amine are formed again. The solution can thus be reused for the gas scrub. Electrical neutrality results in the amount of base produced corresponding precisely to the amount of sulfide oxidized.

Any hydrogen sulfide liberated on acidification of the disulfide solution is completely resorbed in the cathode space by the excess of alkali equivalents, so that only low emissions are liberated.

The acid required for precipitation of the sulfur from the disulfide solution can be added separately. However, it is also possible to prepare this acid electrochemically. If, for example, part of the solution after precipitation of the sulfur is recirculated to the anode space of an electrolysis cell having the same structure, water rather than sulfide is oxidized at the pH prevailing there. While alkali and hydrogen are formed in the cathode space as in the electrolysis of hydrogen sulfide, an acid is formed on the anode side. This can be used to initiate the precipitation of sulfur.

When sodium chloride is used as supporting electrolyte, it is possible, for example, for this firstly to be dissolved in the amine scrubber solution. The sodium ions are very suitable for passing through the cation-conducting membrane used. In the anode space of the electrolysis cell, sulfide ions are oxidized to disulfide ions without precipitation of sulfur being observed. To balance the charge, two sodium ions go through the membrane into the cathode space. In the cathode space, water is reduced and hydrogen and hydroxide ions are formed. The chloride ions remain in the anode space and together with the ammonium cations form ammonium chloride. This results in a decrease in the pH of the solution. After a conversion of 50%, based on the original concentration of sulfide, only the disulfide ions are present in the solution. Further electrolysis would form trisulfide ions. However, these are not stable at the pH used and decompose into sulfur and sulfide.

In the cathode space, the hydroxide ions formed there deprotonate the chloride of the ammonium cations and reform sodium chloride and free amine which can once again be used for the gas scrub. Electrical neutrality results in the amount of base produced corresponding precisely to the amount of sulfide oxidized. In this way, precisely as much chloride as cation of the amine is produced.

Due to the excess of the supporting electrolyte in the amine scrubber solution, the conductivity of the solution remains largely constant over the entire course of the electrolysis.

The pH at which the formation of sulfur can be suppressed is, independently of the amine scrubber used, preferably in the range from 7.5 to 8.5

The use of a supporting electrolyte can be dispensed with when an anion-conducting membrane rather than a cation-conducting membrane is used as membrane. When an anion-conducting membrane is used, the sulfide ions comprised in the amine scrubber solution migrate through the membrane. The sulfide ions have a sufficiently good conductivity through the anine-conducting membrane for the addition of a supporting electrolyte not to be necessary.

Suitable anion-conducting membranes are, for example, membranes which comprise a polymer having quaternary ammonium groups or phosphonium groups. One suitable anion-conducting membrane is, for example, FUMASEP FAA® from FuMA-Tech GmbH.

In a particularly preferred embodiment, at least one supporting electrolyte is added and an anion-conducting membrane is used. This has the advantage that the total conductivity is increased by the addition of the supporting electrolyte and the energy consumption of the electrolysis can be reduced as a result. Suitable supporting electrolytes are the same salts which have been described above. Particularly preferred salts here are also salts of the alkali metals, in particular halides of the alkali metals and very particularly preferably sodium chloride.

The amine scrubber solution which is used for removal of hydrogen sulfide from the gas stream is preferably an aqueous solution comprising at least 10% by volume of methyldiethanolamine (MDEA), diethanolamine (DEA), aminoethoxyethanol (ADEG), diisopropanolamine (DIPA) or potassium N,N-dimethylaminoacetate. The proportion of methyldiethanolamine (MDEA), diethanolamine (DEA), aminoethoxyethanol (ADEG), diisopropanolamine (DIPA) or potassium N,N-dimethylaminoacetate in the amine scrubber solution is particularly preferably in the range from 30 to 50% by volume.

Among these amines, particular preference is given to potassium N,N-dimethylaminoacetate. An advantage of the use of potassium N,N-dimethylaminoacetate is that even when a cation-conducting membrane is used it is not necessary to add an additional supporting electrolyte. In the electrolysis, the potassium ion can pass through the cation-conducting membrane.

When the amine scrubber solution is an aqueous solution comprising potassium N,N-dimethylaminoacetate, it preferably comprises at least 10% by volume of potassium N,N-dimethylaminoacetate. In particular, the proportion of potassium N,N-dimethylaminoacetate in the amine scrubber solution is in the range from 30 to 48% by volume.

The conductivity of a solution comprising potassium N,N-dimethylaminoacetate is initially very low but the conductivity increases with saturation with hydrogen sulfide to a sufficiently high value. Thus, the conductivity of a 40% strength aqueous solution of potassium N,N-dimethylaminoacetate can increase to 100 mS/cm after saturation with hydrogen sulfide. This value is sufficient for the electrolysis to be carried out. However, a further improvement in the electrolysis can be achieved by addition of a supporting electrolyte.

Illustrative embodiments of the invention are shown in the drawings and are described in more detail in the following description.

In the drawings:

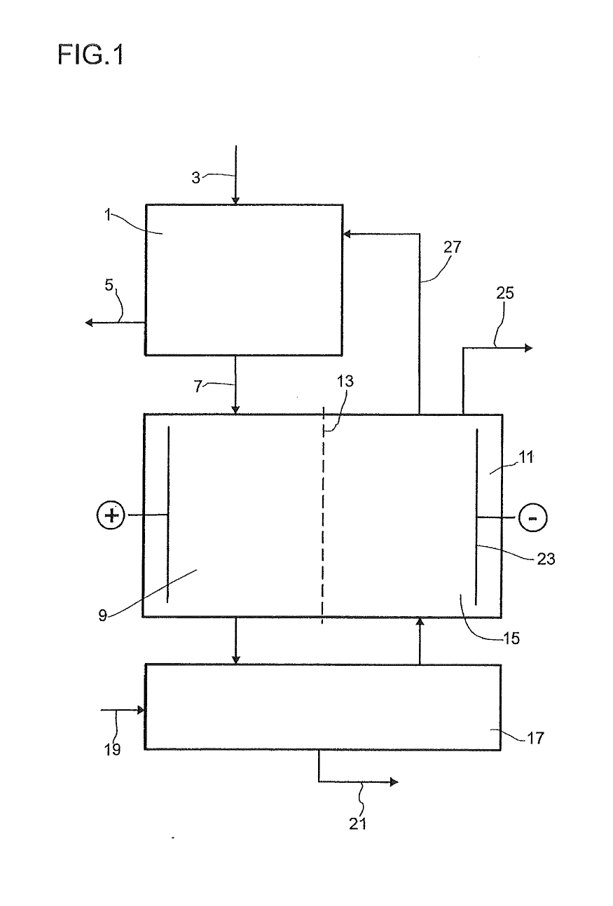

FIG. 1 shows a flow diagram of offgas purification with an electrolysis cell for the dissociation of hydrogen sulfide,

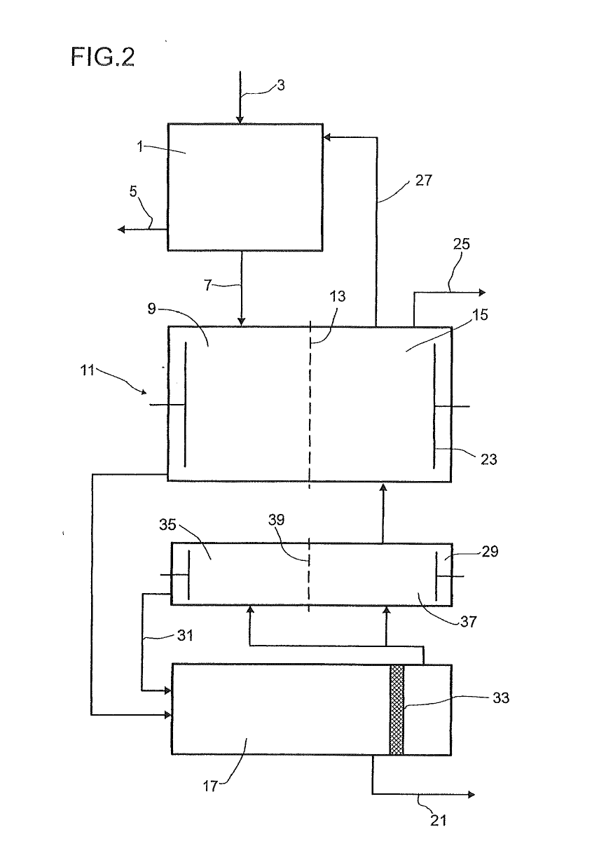

FIG. 2 shows a flow diagram of offgas purification with an electrolysis cell for the dissociation of hydrogen sulfide and an acid electrolysis.

FIG. 1 shows a flow diagram of offgas purification with an electrolysis cell for the dissociation of hydrogen sulfide.

A hydrogen sulfide-comprising offgas which is to be purified is fed to an amine scrubber 1 via a feedline 3. The offgas originates, for example, from the petroleum- or natural gas-processing industry. Thus, natural gas comprising hydrogen sulfide, for example, can be fed to the amine scrubber 1, so that hydrogen sulfide is removed from the natural gas in the amine scrubber 1. As an alternative, the offgas fed to the amine scrubber 1 can also be, for example, any other refinery gas obtained in the petroleum- or natural gas-processing industry. Any other offgas comprising hydrogen sulfide can also be fed to the amine scrubber 1.

Any gas scrubber known to those skilled in the art is suitable as amine scrubber 1. Scrubbing columns, for example, in which the gas to be purified is passed through a scrubbing liquid comprised therein or in which a scrubbing liquid is sprayed into a column are usually used as gas scrubbers. Further suitable scrubbers are, for example, Venturi scrubbers, jet scrubbers or scrubbing columns. Depending on the construction of the amine scrubber 1, it can be operated either in cocurrent or in countercurrent. The purified offgas, i.e. the offgas from which the hydrogen sulfide has been removed, is taken off from the amine scrubber 1 via an offtake 5.

An aqueous solution of an amine is used as scrubbing liquid in the amine scrubber 1. Amines usually used are, for example, methyldiethanolamine, diethanolamine, aminoethoxyethanol, diisopropanolamine or potassium N,N-dimethylaminoacetate. The hydrogen sulfide dissolves in the scrubber solution with formation of hydrogensulfide ions and amine cations by protonation of the nitrogen atom in the amine. The amine scrubber solution in which the hydrogen sulfide has been dissolved is fed via a feedline 7 to an anode space 9 of an electrolysis cell 11. In the anode space 9, a disulfide is formed from sulfide ions comprised in the amine scrubber solution with release of two electrons. The necessary charge balance is achieved by cations being transported through a cation-conducting membrane 13 into a cathode space 15. According to the invention, the cations are the cations of a supporting electrolyte which is added to the amine scrubber solution. The cations of the amine comprised in the amine scrubber solution are generally too large for transport through the pores of the cation-conducting membrane 13.

The electrolyte from the anode space 9 is fed to an apparatus for the precipitation of sulfur 17. In order to reduce the pH, acid is added to the apparatus for the precipitation of sulfur 17 via an acid feedline 19. As a result of the addition of acid, the disulfide is decomposed into sulfur and sulfide. The sulfur precipitates. The precipitated sulfur is taken off from the apparatus for the precipitation of sulfur 17 via a sulfur offtake 21.

From the apparatus for the precipitation of sulfur 17, the aqueous amine solution which still comprises the sulfide ions is conveyed to the cathode space 15 of the electrolysis cell 11. In the cathode space 15, hydrogen is formed with uptake of electrons from the cathode 23. At the same time, the amine is once again converted into the uncharged state by the formation of hydrogen. The hydrogen is taken from the process via a hydrogen offtake 25. The aqueous amine solution, which still comprises sulfide, is conveyed as scrubbing solution back into the amine scrubber 1 via a line 27 by means of which the cathode space 15 is connected to the amine scrubber 1.

FIG. 2 shows a flow diagram of offgas purification with an electrolysis cell for the dissociation of hydrogen sulfide and an acid electrolysis.

The embodiment shown in FIG. 2 differs from the embodiment shown in FIG. 1 in that the acid required for the precipitation of sulfur is prepared in an acid electrolysis cell 29. The acid goes from the acid electrolysis cell 29 via an acid line 31 into the apparatus for the precipitation of sulfur 17. In the embodiment shown here, a filter element 33 is provided in the apparatus for the precipitation of sulfur 17 in order to remove solids, for example precipitated sulfur, from the solution. Any filter element known to those skilled in the art is suitable as filter element 33. A corresponding filter element 33 can of course also be provided in the apparatus for the precipitation of sulfur 17 shown in FIG. 1. Suitable filter elements 33 are, for example, filter presses, centrifugal purification filters, plate filters, decanter centrifuges and belt filters. However, any other suitable filter element known to those skilled in the art can also be used.

After filtration through the filter element 33, the solution is fed to the acid electrolysis cell 29. Here, the solution is introduced uniformly into the anode space 35 and the cathode space 37 of the acid electrolysis cell 29. The structure of the acid electrolysis cell 29 preferably corresponds to that of the electrolysis cell 11. The anode space 35 and the cathode space 37 of the acid electrolysis cell 29 are likewise separated from one another by a membrane 39. The membrane is preferably made of the same material as the membrane 13 of the electrolysis cell 11. An electrolysis of water takes place in the acid electrolysis cell 29, with hydrogen and the base of the cation of the supporting electrolyte being formed in the cathode space 37 of the acid electrolysis cell 29 and the acid of the anion of the supporting electrolyte being formed in the anode space 35 of the acid electrolysis cell 29. This acid is then conveyed via the acid line 31 into the apparatus for the precipitation of sulfur 17. From the cathode space 37 of the acid electrolysis cell 29, the solution is conveyed further into the cathode space 15 of the electrolysis cell 11.

Sodium chloride is preferably used as supporting electrolyte. When sodium chloride is used as supporting electrolyte, hydrochloric acid is formed in the anode space 35 of the acid electrolysis cell 29 and sodium hydroxide and hydrogen are formed in the cathode space 37 of the acid electrolysis cell 29.

The advantage of the use of the acid electrolysis cell 29 is that the amount of acid produced corresponds precisely to the amount of base produced in the cathode space 37 of the acid electrolysis cell 29. In this way, the acid-base balance is maintained. In particular, it has been found that when sodium chloride is used as supporting electrolyte, no oxygen formation occurs at the anode. In addition, no by-products such as sulfites, thiosulfates or sulfates are formed. A further advantage of the use of the supporting electrolyte, in particular sodium chloride, is that the conductivity of the solution remains largely constant during the entire course of the electrolysis.

When potassium N,N-dimethylaminoacetate is used, the potassium ions can be transported through the cation-conducting membrane 13. The use of an additional supporting electrolyte is therefore not necessary.

As an alternative to the embodiments shown in FIGS. 1 and 2, it is also possible to use an anion-conducting membrane instead of the cation-conducting membrane 13. In this case, the sulfide ions are transported through the anion-conducting membrane from the cathode space 15 of the electrolysis cell 11 into the anode space 9 of the electrolysis cell 11.

### EXAMPLES

### Example 1

The electrolytic dissociation of hydrogen sulfide is carried out using an electrolysis cell in which the anode space and the cathode space are separated by a cation-conducting membrane. A Nafion® membrane is used as cation-conducting membrane. Graphite plates having a surface area of 100 cm² are used as anode and cathode. The electrolysis was carried out at room temperature and under atmospheric pressure. During the experiment, the electrolyte heated up as a result of ohmic heat losses.

The anode circuit is filled with 532 g of an amine scrubber solution in which hydrogen sulfide has been absorbed. To produce the amine scrubber solution, 200 g of methyldiethanolamine and 300 g of water are placed in a scrubbing tower. 80 g of NaCl are dissolved in the solution. An empty wash bottle and a wash bottle filled with NaOH solution for absorbing excess hydrogen sulfide are connected to the scrubbing tower. Hydrogen sulfide gas is passed into the solution until the solution is saturated and no more hydrogen sulfide is absorbed. 35 g of hydrogen sulfide are absorbed by the solution. The specific conductivity of the solution is 72 mS/cm.

The cathode circuit of the electrolysis cell is filled with 500 g of 1N NaOH solution. The offgas from the anode circuit is tested for formation of oxygen by means of an oxygen sensor. Both circuits are blanketed with 40 l/h of nitrogen.

A constant electric current of 30 A (3000 A/m²) is employed for the electrolysis. After about 24 Ah (44% conversion) and a pH of 8 in the anode circuit, precipitation of sulfur is observed. If the electrolysis is stopped at pH 8, no sulfur precipitates. Sulfur which has already precipitated redissolves at a pH of >8.

### Example 2

An electrolysis is carried out in an electrolysis cell as described in example 1. However, the anode circuit is charged with 537 g of an amine scrubber solution based on potassium N,N-dimethylaminoacetate. To produce the solution, 200 g of potassium N,N-dimethylaminoacetate and 300 g of water are placed in a scrubbing tower. An empty wash bottle and a wash bottle filled with sodium hydroxide solution for absorbing excess hydrogen sulfide are connected to the scrubbing tower. Hydrogen sulfide gas is then passed into the scrubbing solution until the solution is saturated. 49 g of hydrogen sulfide are absorbed by the solution. The specific conductivity of the solution is 118 mS/cm.

The cathode circuit of the electrolysis cell is filled with 500 g of 1N KOH solution. The offgas from the anode circuit is tested for formation of oxygen by means of an oxygen sensor. Both circuits are blanketed with 40 l/h of nitrogen.

A constant electric current of 20 A (2000 A/m²) is employed. After about 34 Ah (44% conversion) and a pH of 8.5 in the anode circuit, precipitation of sulfur is observed. If the electrolysis is stopped at pH 8.5, no sulfur precipitates. Sulfur which has already precipitated redissolves at a pH of >8.5.

### Example 3

An electrolysis cell in which the anode space and the cathode space are separated by a cation-conducting membrane made of Nafion® is used. Graphite rods having a diameter of 12 mm are used as anodes and cathodes. The electrolysis was carried out at room temperature and under atmospheric pressure. During the experiment, the electrolyte heated up as a result of ohmic heat losses.

The anode circuit of the electrolysis cell is filled with 44 g of an amine scrubber solution and the cathode circuit is filled with 34 g of the amine scrubber solution. The amine scrubber solution is produced as described in example 1. A constant electric current of 1 A (about 885 mA/cm²) is employed for the electrolysis. After about 2.0 Ah (50% conversion) and a pH of 8 in the anode space, precipitation of sulfur is observed. If the electrolysis is stopped at pH 8, no sulfur precipitates. Sulfur which has already precipitated redissolves at a pH of >8.

### Example 4

An electrolysis cell as described in example 3 is used. However, an anion-conducting membrane (FUMASEP FAA®) is used instead of the cation-conducting membrane. The electrolysis is likewise carried out at room temperature and under atmospheric pressure. During the experiment, the electrolyte heats up as a result of ohmic heat losses. The anode circuit is filled with 35 g of an amine scrubber solution and the cathode circuit is filled with 33 g of the amine scrubber solution. The amine scrubber solution is produced as described in example 1. A constant electric current of 0.7 A (about 620 mA/cm²) is employed for the electrolysis. After about 1.4 Ah (44% conversion) and a pH of 8 in the anode space, precipitation of sulfur is observed. If the electrolysis is stopped at pH 8, no sulfur precipitates. Sulfur which has already precipitated redissolves at a pH of >8.

### LIST OF REFERENCE NUMERALS

1 amine scrubber
3 feedline
5 offtake
7 feedline
9 anode space
11 electrolysis cell
13 cation-conducting membrane
15 cathode space
17 apparatus for precipitation of sulfur
19 acid feedline
21 sulfur offtake
23 cathode
25 hydrogen offtake
27 line
29 acid electrolysis cell
31 acid line
33 filter element
35 anode space of the acid electrolysis cell 29
37 cathode space of the acid electrolysis cell 29
39 membrane

1-11. (canceled)

12. A process for the electrolytic dissociation of hydrogen sulfide dissolved in an amine scrubber solution in an electrolysis cell which has an anode space and a cathode space, with the anode space and the cathode space being separated by a membrane, wherein at least one of the following features is present:
(a) using a cation-conducting membrane for separating anode space and cathode space and addition of at least one supporting electrolyte to the amine scrubber solution, or
(b) dissolving the amine scrubber solution in which the hydrogen sulfide comprises at least 10% by volume of potassium N,N-dimethylaminoacetate.

13. The process according to claim 12, wherein when the at least one supporting electrolyte is added and/or when an amine scrubber solution comprising at least 10% by volume of potassium N,N-dimethylaminoacetate is used, a cation-conducting membrane is used for separating anode space and cathode space.

14. The process according to claim 12, wherein the supporting electrolyte is a salt of an alkali metal.

15. The process according to claim 12, wherein the anion of the supporting electrolyte is selected from the group consisting of sulfate, sulfide, phosphate, hydroxide, halide, carbonate and hydrogensulfide.

16. The process according to claim 12, wherein the supporting electrolyte is an organic salt of an alkali metal.

17. The process according to claim 12, wherein the proportion of supporting electrolyte in the amine scrubber solution comprising the hydrogen sulfide is in the range from 1 to 13.8% by weight.

18. The process according to claim 12, wherein the anion-conducting membrane comprises a polymer having quaternary ammonium groups or phosphonium groups.

19. The process according to claim 12, wherein the amine scrubber solution is an aqueous solution comprising at least 10% by volume of methyldiethanolamine, diethanolamine, aminoethoxyethanol, diisopropanolamine or potassium N,N-dimethylaminoacetate.

20. The process according to claim 19, wherein the amine scrubber solution is used in an offgas scrubber.

21. The process according to claim 20, wherein the offgas scrubber is used for scrubbing offgases from the petroleum or natural gas industry.

22. A process for removing hydrogen sulfide from an amine scrubber solution which comprises utilizing utilizing the process according to claim 12.
